(19) United States
(12) Patent Application Publication
(10) Pub. No.: US 2004/0059553 A1
(43) Pub. Date: Mar. 25, 2004

(54) Method and device for automatically generating simulation programs

(76) Inventors: Luder Heidemann, Erlangen (DE); Hansjurgen Seybold, Erlangen (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/670,965

(22) Filed: Sep. 25, 2003

(30) Foreign Application Priority Data
Mar. 20, 2002 (WO) PCT/DE02/01014
Mar. 29, 2001 (DE) 10115694.4
Sep. 27, 2001 (DE) 10147740.6

(51) Int. Cl. G06G 7/48

(52) U.S. Cl. 703/6

(57) ABSTRACT

In order to automatically generate simulation programs, basic program operations of a real program are made available in the recipe management. Furthermore, process parameters of the real process are made available in the sequence logic (SFC). The basic program operations are automatically linked to the process parameters in order to simulate the method, whereby a simulation model is generated that is initialized according to the real process. Method simulation is advantageously controlled simultaneously by the process control system of the real process. Parallel running of the real process with the simulation process enables effective monitoring and improved maintenance management.

The present invention relates to a device and method for producing simulation programs according to the preamble of claim 1 and in particular for maintaining systems.

Necessary maintenance measures are generally carried out on an event-controlled or time-triggered basis. With event-controlled maintenance measures, a process component will be replaced or repaired if it has failed. In the case of time-triggered maintenance, on the other hand, maintenance measures are performed at regular intervals, the aim being to prevent outage of the process facility.

Preventive maintenance is of paramount importance especially where highly complex facilities are concerned: The outage, for instance, of a production facility can give rise to very high costs. That is why complex facilities are frequently monitored by sensors and the measurements used to detect a need for maintenance. This typically entails performing measurements on components of a facility and recording these measurements during the process. Changes in the measurements allow tendencies to be recognized that may necessitate maintenance measures. For example, pressure may rise in a facility over time, indicating a blocked pipeline, for instance. As further examples, vibrations may point to a worn bearing and measurements performed on the phase angle delta in a motor drive may indicate unfavorable drift. However, not in every facility can individual components be constantly monitored for wear and the like: Monitoring may be uneconomical in the case, for example, of very high process temperatures or facilities of very compact physical design, or if individual components are extremely complex.

Process simulation programs are used for engineering and testing facilities and processes. Simulation programs of this type are produced by specialists and adapted to suit individual needs. It is accordingly very expensive to produce simulation programs for large facilities or for multi-layer processes.

The object of the present invention is thus to simplify the production of simulation programs in particular with regard to maintenance measures.

This object is achieved according to the invention by means of a method for producing a simulation program by making available basic program operations and making available process parameters of a real process and automatically linking the basic program operations to the process parameters for initializing the simulation program.

The above object is further achieved by means of a device for simulating a system with a storage facility for making available basic program operations and with a control device for simulating a real process on the basis of the basic program operations, and with a read-in device for reading in process parameters of the real process wherein, by means of the control device, the basic program operations for a simulation process can be automatically linked to the process parameters for initializing the simulation process.

The simulation model or program can advantageously be automatically derived from the real process by means of the invention. No additional engineering effort will therefore be required if the control of the real facility has already been provided. This will increase the level of user acceptance in terms of employing simulation models, in particular for maintenance purposes.

Further advantageous developments of the device according to the invention and of the method according to the invention can be found in the subclaims.

The present invention will now be described in more detail with the aid of the attached drawings, in which

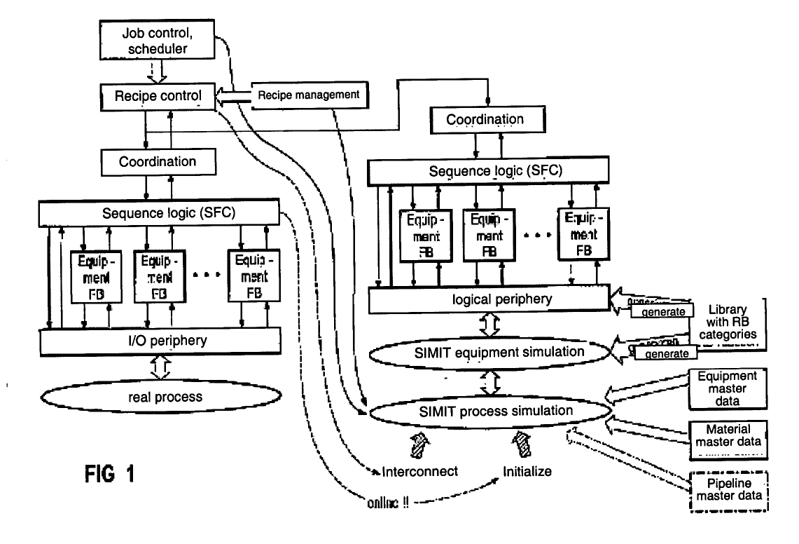

FIG. 1 shows a data flow diagram of a real process and a simulation process running in parallel according to the invention;

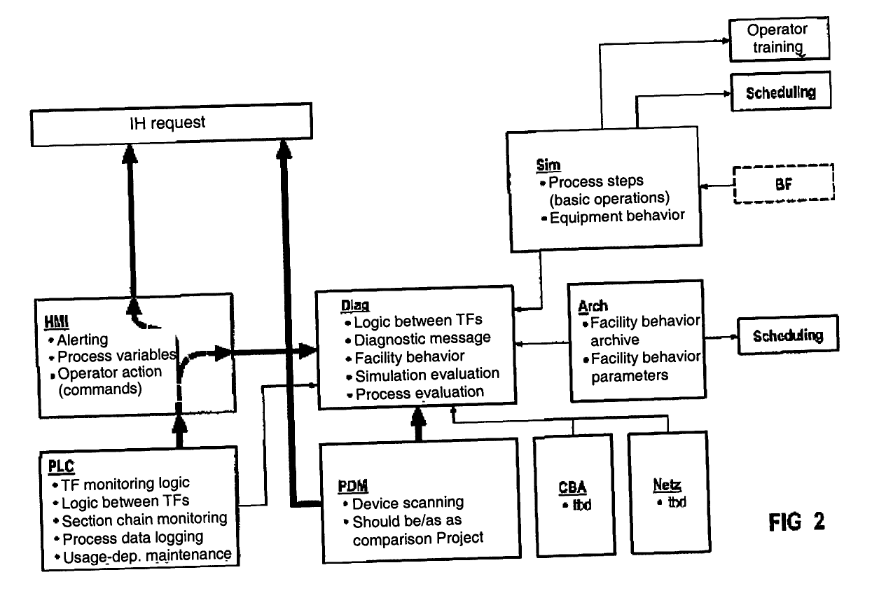

FIG. 2 shows a signal flow diagram for alerting and predicting a need for maintenance; and

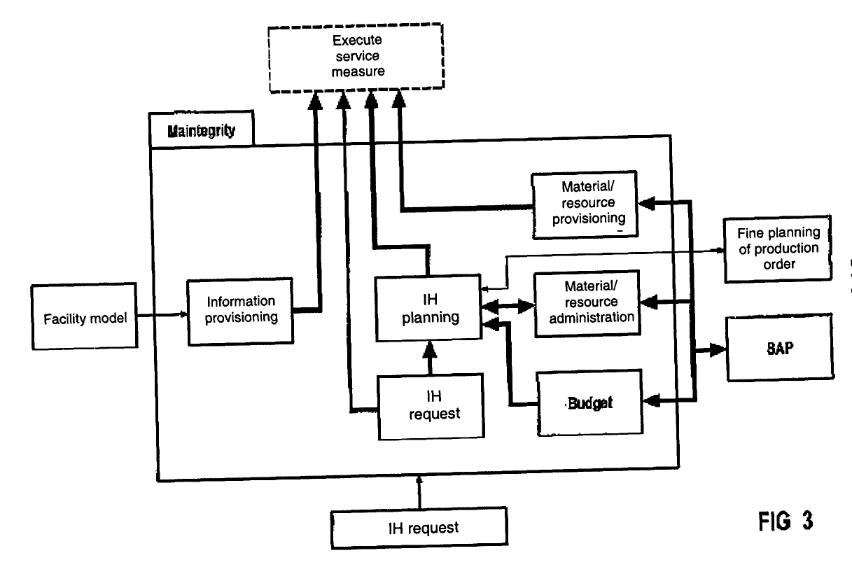

FIG. 3 shows a signal flowchart for implementing maintenance measures.

The exemplary embodiments described below show preferred embodiments of the present invention.

FIG. 1 shows, in its left half, a schematic signal flowchart of a control of a real process and, in its right half, that of a simulation process running in parallel. The job control, or what is called a scheduler, serves as a starting point for controlling the real process. A recipe control (batch flexible) is driven with the job data. The recipe control obtains the required recipe(s) from a database, namely recipe management. This drive is suitable for both batch-processing processes (batch) and continuous processes.

Actual facility control or automation takes place in the block in FIG. 1 designated “sequence logic”. A separate component between the recipe control and sequence logic coordinates the instructions with regard to semantics.

The sequence logic is associated with several function blocks FB which are responsible for automating individual steps. Via an input/output periphery the sequence logic and function blocks then exchange instructions and measurements with the process components of the real process. A simple production process performed within a simplified facility could serve as an example of a real process. A container is linked to a reactor via a pipe. The reactor contains two generating sets, a mixer, and a heater set. The container is filled with a certain material. During the production process the reactor could first be filled with the material from the container then heat and mix said material. The relevant process steps are filling, heating, and mixing. Each of these individual process steps or basic operations has its own internal sequence of instruction steps which is implemented in the sequence logic. The process step ‘fill’ may, for example, comprise the instructions: Check status of cellular wheel sluice, open slide gate, check fill level etc. In a recipe for producing a certain material the individual process steps are precisely specified. Similar to a cooking recipe, the control recipe contains parameters such as process times, process temperatures etc. A set sequence of process steps is also specified.

The individual process steps are sequenced in the sequence logic and the respective start and end time specified. Facility components are individually controlled by function modules as directed by the sequence logic.

A corresponding simulation process is shown on the right-hand side of the figure in FIG. 1. Like the real process system, the simulation system consists of a coordination module followed by the sequence logic and equipment function modules. The input/output periphery of the real process is simulated by a logical periphery. The real process itself must be simulated, on the one hand, in its components and, on the other hand, in the process flow itself. The components are simulated in what is called an equipment simulation, and the equipment simulation modules are suitably linked together for the process simulation.

The logical periphery and equipment simulation can be generated automatically by a semantics manager from a library of RB categories (reaction modules).

Equipment master data, material master data, and pipeline master data etc. flow into the process simulation. Equipment master data comprises, for example, the diameter of containers, features of valves, pumps etc. Material master data comprises quantities, grain size distribution etc. of the material used. Lastly, the pipeline master data corresponds to dimensions and other relevant variables of the pipelines used. All the master data can be filed in libraries.

The real process is then synchronized with the simulation process. The two processes consequently run in parallel so as to make a direct comparison of the process results possible. It is not necessary here to simulate the entire real process; instead, a particularly critical process step, for example, can be simulated which requires, for instance, constant monitoring.

The simulation allows the entire facility and/or major parts of it to be simulated as a virtual facility. Selectively simulating parts of the facility and comparing the relevant virtual and real process steps allow the need for maintenance to be localized to a degree commensurate with the size of the simulation component. For example, critical parts of the facility can be subdivided into finer process steps in order better to localize the need for maintenance. Where non-critical parts of the facility are concerned, several components can be combined both during measuring of the real process and during the simulation. If a fixed deviation or a deviation increasing with time is then detected on the basis of the comparison of the results of process steps in the real and virtual process, appropriate maintenance measures can be initiated.

The behavior of a facility from a process control viewpoint is examined so that a need for maintenance can be detected in a timely fashion. This means that, for example, the vibrating of a pump is not measured so that conclusions can be drawn about a worn bearing; instead, the flow through the pump is measured and compared with a simulated ideal flow so that the pump's aging can be detected.

In a development of the invention it would also be possible to simulate the behavior of the material which is contained within the facility and being processed. Conclusions could be drawn about the facility from the simulated and real chemical conversion process. For example, deviations in a material's physical state, such a viscosity, could indicate a defective cooling device. Equally, differences between the simulated and measured PH value, for instance, could indicate a defective mixer.

Whether the physical parameters of the material located within the facility or typical variables of the facility, such as the throughput rate, are used for diagnostic purposes, is of secondary importance provided the simulation process runs, according to the invention, in parallel with the real process and individual results of process steps or overall results of the process as a whole are compared. For the respective comparison it is necessary for the start and end of each process step being compared to be defined and recognized. Unique indicators for a need for maintenance can also be determined. For example, unusually long filling times or excessive heating times can be recognized that deviate from normal facility operation. These differences do not necessarily result in an outage of the entire facility or the production of rejects; they may merely indicate that the facility is not running according to the planned optimum.

Appropriate maintenance measures can be carried out in keeping with the magnitude of the deviations. Simply a warning can be directed to the maintenance team if there is only a slight difference between the real and simulated process. In the case of major differences a fault message can be issued signaling an immediate need for maintenance.

The diagnostic information obtained from parallel running of the real and simulated process can also be used to optimize the facility. If, for example, the facility is run using a changed recipe, the process steps and/or their sequence will also change. The facility controller or scheduler converts the new recipe into time flows or time slices. In the case of multi-material facilities, for example, these time slices must be coordinated as a function of the different materials and facility components. The aim here is to utilize all parts of the facility to optimum capacity. To improve scheduling online, the simulation process can run in parallel with the real process. Optimization can thereby be achieved without the need for the facility to be idle.

In the case of large facilities and multi-layer processes, controlling the real process requires a high level of engineering effort. The simulation model or program is produced automatically so that this engineering effort does not have to be repeated. For this, basic operations made available in the recipe management and job control are automatically linked with each other in the process simulation. To initialize the simulation program the process parameters of the real process are read out by the SFC sequence logic online. This means the simulation program is automatically provided with the process parameters of the real process, resulting in an exact physical and time-related simulation of the real process.

The process simulation is favorably co-controlled by the job control of the real process. It is, however, also possible to provide a separate control for the simulation. Direct linking in control terms to the real process is, however, especially advantageous for automatic engineering.

For automatic engineering, a simulation model must furthermore be adapted in data terms to the control of the real process. An accordingly adapted generic simulation model of a basic operation has, for example, a set of parameters consisting of parameter triples. A triple consists of the “material(s)” parameter, which is product-dependent, the “unit” parameter, which defines the respectively used container, and the “job” parameter, which defines the respectively affected amount of material. The parameters are known from the production recipes. The simulation model is then initialized via this set of parameters so that it corresponds to the real process that is running.

As the simulation models of the basic operations required for production are independent of the recipes required for production (“generic”) and the simulation, including its provisioning with parameters, is controlled by the process control system, no additional engineering effort is required for the parallel simulation.

The simulation models are produced in principle automatically from the recipes of the real process. The simulation models can generally be produced from semantic programs, semantic periphery assignments and/or process control engineering documents, which is to say from information which the virtual facility needs for describing its components and how these interact. This information is converted for automatic operation into parameterizing and interconnecting the virtual facility.

As already mentioned, a meaningful comparison between real and simulated process steps requires precise synchronizing. A precise starting point must also be specified, which is done by initializing.

As indicated in FIG. 1 by a broken line, initializing of the simulation process can be controlled online by the sequence logic of the original facility. For example, it is possible to ensure that a container in the original facility and in the simulation has in each case a defined fill level at a specific process step in a specific recipe.

The single arrows in FIG. 1 signify signal links or action links, and the double arrows signify data connections which are necessary for, for example, parameterizing and engineering.

FIG. 2 shows a schematic signal flowchart for obtaining a maintenance request on the basis of the diagnosis resulting from the comparison between the real process and simulation process running in parallel. Explanations of the modules can be found in the table at the end of the description.

FIG. 3 shows a signal flowchart showing further processing of a maintenance request in a maintenance management system. According to this, service measures are performed if necessary on the basis of information provisioning, material/resource provisioning, maintenance planning, and the maintenance request. Material/resource administration and the budget have an impact here on maintenance planning. The facility model also serves for information provisioning.

TABLE

| Component | Function | Task |
|---|---|---|
| PLC | Logic in TF | Suppression of follow-up |
| | | message. |
| | | Example 1: Outage of the |
| | | alerting voltage (simultane- |
| | | ously) takes all the messages |
| | | from the monitoring loop fed |
| | | by the alerting voltage (“con- |
| | | tacts”) |
| | | Example 2: All messages must |
| | | be suppressed in on-site op- |
| | | eration (from a repair |
| | | counter) |
| | | Module message |
| | | Example 1: Check-back monitor- |
| | | ing (protective check-back, |
| | | rotation speed check-back, op- |
| | | erating time message) |
| | | Example 2: Operating mode |
| | | changeover |
| | Process data logging | Make process values available |
| | | that are required for cross- |
| | | area logic (event-triggered, |
| | | in the case of measurements |
| | | for change with dead band) |
| | Logic between TFs | Technological monitoring of a |
| | | PLT location. |
| | | Example 1: A jump in setpoint |
| | | value on a regulator must re- |
| | | sult a rise in the actual |
| | | value. |
| | | Example 2: Manipulated vari- |
| | | able of a regulator increases |
| | | with no change in the setpoint |
| | | value (wear on valve seating) |
| | | Example 3: Pressure or flow |
| | | measurement on pump group |
| | Usage-dependent | Operating cycle/operating time |
| | maintenance | counter |
| | | Count the operating hours or |
| | | operating cycles, generate IH |
| | | request if a parameterized |
| | | threshold is exceeded |
| | Section chain | Time monitoring for indexing |
| | monitoring | condition |
| PDM | Scan field devices | Information from intelligent |
| | | field devices |
| | | PDM (AMS) scans the accessible |
| | | field devices and transfers |
| | | messages (selected by parame- |
| | | terizing) |
| | | Live monitoring of intelligent |
| | | field devices |
| | | PDM (AMS) scans the planned |
| | | field devices and generates a |
| | | message if a planned device |
| | | cannot be accessed. |
| | Should be/as is | Comparison planning - |
| | comparison | as is |
| | Project | PDM (AMS) scans the accessible |
| | | field devices and generates a |
| | | message if planning is not as |
| | | is (read field device not in |
| | | the project). |
| CBA | | |
| CM | Condition monitoring | Example 1: Vibration monitor- |
| | | ing on machine |
| | | Example 2: Electrical finger- |
| | | print for motor |
| | | Example 3: HISS (smell, hear, |
| | | taste) |
| HMI | Operation of | Example: “Standard deviation” |
| | operating or | parameter for fault message |
| | recipe parameters | dependent on operating mode |
| | Alarms | Planned alarms = IH request |
| Diag | Facility behavior | Comparison of current facility |
| | | behavior with history. |
| | | Example 1: How long has it |
| | | taken so far to bring material |
| | | x in unit y from m to n fill |
| | | height? Comparison with cur- |
| | | rent step. |
| | | IH request via user action |
| | | with GUI support. User gener- |
| | | ates IH request |
| | | Necessary: Facility behavior |
| | | archive or (at least) param- |
| | | eterized comparison values |
| | Logic between TFs | Technological monitoring of |
| | | part of a facility |
| | | Logic or rules on a cross-area |
| | | basis over several PLT loca- |
| | | tions (on several PLCs, where |
| | | applicable) |
| | Diagnostic message | Message frequency |
| | | Example 1: Specific report |
| | | numbers from a specific TP are |
| | | (interactively) “set to diag- |
| | | nosis” and continuously moni- |
| | | tored from then on until a |
| | | suspected fault cause has been |
| | | recognized/analyzed. |
| | | Example 1: Suspicion of in- |
| | | creased outage rate of a motor |
| | | drive: The report numbers, |
| | | protective check-back, and bi- |
| | | metal message generate a diag- |
| | | nostic message if more than 5 |
| | | messages occurred per shift. |
| | Simulation | Compare the result of process-/ |
| | evaluation | equipment simulation with |
| | | real process/facility results. |
| | | Decision rules specifying when |
| | | a comparison between simula- |
| | | tion result and as-is facility |
| | | is ok/not ok and (in the case |
| | | of process simulation) assign- |
| | | ment to asset. |
| | Behavior evaluation | Compare value from facility |
| | | behavior archive or from fa- |
| | | cility behavior (with fixed |
| | | values determined in IBS/trial |
| | | operation) with real facility |
| | | results. Otherwise as above. |
| | | Note: |
| | | Simulation evaluation is ad- |
| | | vantageous in the case of |
| | | multi-purpose facilities where |
| | | a meaningful facility behavior |
| | | archive is not ensured on ac- |
| | | count of the multiplicity of |
| | | products/recipes. |
| | | Behavior evaluation is advan- |
| | | tageous in the case of “sin- |
| | | gle-purpose” facilities and |
| | | conti/semiconti facilities. |
| Sim | Process simulation | Technological monitoring of |
| | | recipe steps |
| | | SIMIT has models of the facil- |
| | | ity Gos (mix, heat, fill |
| | | etc.). Each individual model |
| | | has parameters (material, |
| | | unit, and product parameters). |
| | | The simulation runs under BF |
| | | control (BF gives the step |
| | | start, with the parameter set |
| | | valid for the step and the end |
| | | criterion (e.g. final tempera- |
| | | ture 92° C.), to SIMIT. SIMIT |
| | | starts simulation and, on at- |
| | | tainment of the end criterion, |
| | | gives the result parameter set |
| | | defined for the GO to Diag. |
| | | SIMIT has (as yet) no command |
| | | of material conversions; op- |
| | | erations of this type (e.g. |
| | | “reaction”, “synthesis”) have |
| | | to be simulated by simple em- |
| | | pirical equations if a pass is |
| | | to be made through several Gos |
| | | in a “simulation chain”. |
| | | No project-specific engineer- |
| | | ing work is necessary because |
| | | this method runs under the |
| | | control of BF. SIMIT “only” |
| | | needs models that are proc- |
| | | ess/project neutral. |
| | Equipment behavior | Technological monitoring of |
| | | the equipment behavior |
| | | SIMIT has models of the (tech- |
| | | nological) equipment behavior |
| | | (e.g. resistance heating ele- |
| | | ment with time behavior, heat |
| | | transition, heat flow in the |
| | | material etc.). |
| | | Otherwise analogous to the |
| | | above |
| Arch | Facility behavior | History of the product- and |
| | archive | substance-/material-dependent |
| | | time behavior of parts of the |
| | | facility, units, equipment, |
| | | and also relevant (fixed) pa- |
| | | rameters. |
| | | Different embodiments for the |
| | | process industry and discrete |
| | | (manufacturing) industry: |
| | | Process industry: Objects are |
| | | steps in the flow such as |
| | | filling, heating etc. and |
| | | equipment (S 88), not the ob- |
| | | jects of the facility model |
| | | such as a pump, regulating |
| | | valve etc. |
| | | Discrete industry: Objects are |
| | | the “machines” of the facility |
| | | model. |

1. Method for producing a simulation program by making available basic program operations and making available process parameters of a real process
characterized by
automatically linking the basic program operations to the process parameters for initializing the simulation program.

2. Method according to claim 1 wherein automatic linking is carried out by a process control system which controls or regulates the real process.

3. Method according to claim 1 or 2 wherein the process parameters are made available by making pre-defined data packets available.

4. Method according to claim 3 wherein the data packets are parameter triples, in particular in each case one parameter for a type of material, a type of container, and an amount of material.

5. Method according to one of the claims 1 to 4 wherein the process parameters are obtained from a production recipe of the real process.

6. Method according to one of the claims 1 to 5 wherein the basic program operations are assembled into the simulation program on the basis of one or more semantic programs, semantic periphery assignments and/or process control engineering documents of the control of the real process.

7. Method for simulating a real process using the process steps according to one of the claims 1 to 5 and according to the further step of controlling the simulation process by means of a process control system of the real process.

8. Method for maintaining a system by
executing a real process in the system,
executing a simulation process according to claim 7 synchronously with the real process, with the simulation process simulating at least a part of the real process,
comparing the simulation process with the real process or the part thereof and obtaining a comparison result from this, and
deriving maintenance measures from the comparison result.

9. Device for simulating a system with
a storage facility for making available basic program operations and for a simulation process and
a control device for simulating a real process on the basis of the basic program operations
characterized by
a read-in device for reading in process parameters of the real process wherein, by means of the control device, the basic program operations for a simulation process can be automatically linked to the process parameters for initializing the simulation process.

10. Device according to claim 9 wherein the control device is integrated in a process control system which controls or regulates the real process.

11. Device according to claim 9 or 10 wherein the process parameters are pre-defined data packets.

12. Device according to claim 11 wherein the data packets are parameter triples, in particular in each case one parameter for a type of material, a type of container, and an amount of material.

13. Device according to one of the claims 9 to 12 wherein the process parameters can be read in by the read-in device from a production recipe storage unit of the real process.

14. Device according to one of the claims 9 to 13 wherein one or more semantic programs, semantic periphery assignments and/or process control engineering documents of a real process can be read in by the read-in device and used by the control device for assembling the basic program operations.

15. Device for maintaining a system in which a real process can be executed, with a simulation device according to one of the claims 9 to 14 for simulating at least a part of the real process by means of a simulation process wherein the simulation process can be executed synchronously with the real process.
